(19) United States
(12) Patent Application Publication
(10) Pub. No.: US 2009/0181683 A1
(43) Pub. Date: Jul. 16, 2009

(54) SYSTEM, DEVICE AND METHOD FOR COMMUNICATION CONTROL IN DUAL TRANSFER MODE

(75) Inventor: Dong Won RYU, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/344,913

(22) Filed: Dec. 29, 2008

(30) Foreign Application Priority Data
Jan. 10, 2008 (KR) 10-2008-0003120

(51) Int. Cl. H04W 40/00; H04M 1/00

(52) U.S. Cl. 455/445; 455/550.1

(57) ABSTRACT

A system, device and method for communication control in a dual transfer mode are disclosed. The method includes performing a voice call by a portable terminal, based on a dual transfer mode, requesting to download data from a server by the portable terminal, determining whether voice information exists to be transmitted to the portable terminal, allocating data intended to be transmitted to the portable terminal, to time slots previously allocated to transfer voice information, if voice information does not exist, and transmitting the allocated data to the portable terminal.

### PRIORITY

This application claims the benefit under 35 U.S.C. §119(a) of a Korean patent application filed on Jan. 10, 2008 in the Korean Intellectual Property Office and assigned Serial No. 10-2008-0003120, the entire disclosure of which is hereby incorporated by reference.

### BACKGROUND OF THE INVENTION

1. Field of the Invention

The present invention relates to communication systems. More particularly, the present invention relates to a system, device and method for communication control in a Dual Transfer Mode (DTM) where a circuit switched based network and a packet switched based network are simultaneously used that allow time slots to carry packets when no data is carried through a voice channel, for improving data transfer efficiency.

2. Description of the Related Art

In a cellular communication system, a geographic area may be divided into a plurality of cells serviced by base stations. Each of the base stations serves as a node for a communication network. In the communication system using a base station, a system is configured to have a switched based structure where base stations share information with each other. The switched based structure is classified into a packet switched based structure and a circuit switched based structure.

Portable terminals may provide various communication services based on the switched based structure. For example, conventional portable terminals may perform communication using the packet switched based structure or the circuit switched based structure, according to their design features. More particularly, a portable terminal operating in a Dual Transfer Mode (DTM) may simultaneously use the packet switched based structure and the circuit switched based structure.

The portable terminal operable in a DTM sets time slots in order to transfer information, i.e., voice and data, through one channel so that the set time slots carry voice and data.

The conventional portable terminal is disadvantageous because data continues to transfer according to a certain transfer rate and the conventional portable terminal has a voice transfer time period and a voice non-transfer time period according to whether a speaker speaks. Accordingly, the conventional portable terminal occupies and wastes a channel during the voice non-transfer time period.

Therefore, a need exists for a system, device and method for transferring data during a non-transfer time period to improve resource use and data transfer efficiency.

### SUMMARY OF THE INVENTION

An aspect of the present invention is to address at least the above-mentioned problems and/or disadvantages and to provide at least the advantages described below. Accordingly, an aspect of the present invention is to provide a system, device and method for performing communication control to transfer data during a voice non-transfer time period in a Dual Transfer Mode (DTM).

In accordance with an aspect of the present invention, a method for communication control in a dual transfer mode is provided. The method includes

performing a voice call by a portable terminal, based on a dual transfer mode; requesting, by the portable terminal, to download data from a server; determining whether voice information exists to be transmitted to the portable terminal; allocating data intended to be transmitted to the portable terminal, to time slots previously allocated to transfer voice information, if voice information does not exist; and transmitting the allocated data to the portable terminal.

In accordance with another aspect of the present invention, a method for communication control in a dual transfer mode is provided. The method includes performing a voice call by a portable terminal, based on a dual transfer mode; generating, by the portable terminal, data to be transmitted; determining whether the portable terminal includes voice information to be transmitted; allocating the data to time slots previously allocated to transfer voice information, if the portable terminal does not have voice information; and transmitting the allocated data.

In accordance with yet another aspect of the present invention, a system for communication control in a dual transfer mode is provided. The system includes one or more portable terminals for performing a voice call in a dual transfer mode; and a network system for supporting resources for the voice call and for performing a controlling operation to transfer data, to at least one portable terminal, through time slots previously allocated to transfer voice information, when at least one portable terminal requests to download data therefrom, wherein the data is transferred according to whether voice information exists that is to be transmitted to the at least one portable terminal requesting to download data.

In accordance with still another aspect of the present invention, a device for communication control between portable terminals performing a voice call in a dual transfer mode is included. The device includes an audio processing unit for collecting voice signals communicated between the portable terminals during a voice call; a data generating unit for generating data communicated between the portable terminals in a dual transfer mode; a Radio Frequency (RF) unit for transferring the voice signals and the data to the other portable terminal; and a controller for performing a controlling operation to transfer data in time slots previously allocated to transfer the voice signals, when the collected voice signals do not exist.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description in conjunction with the accompanying drawings, in which:

FIG. 1 is a schematic view illustrating a system for communication control in a dual transfer mode according to an exemplary embodiment of the present invention;

FIG. 2 is a schematic block diagram illustrating a portable terminal according to an exemplary embodiment of the present invention;

FIG. 3 is a detailed view illustrating a controller according to an exemplary embodiment of the present invention;

FIG. 4 is a flowchart describing a method for communication control in a dual transfer mode according to an exemplary embodiment of the present invention; and

FIG. 5 is a flowchart describing a method for communication control in a dual transfer mode according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms or words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claim and their equivalents.

It is to be understood that the singular forms “a,” “an,” and “the” include plural referents unless the context clearly dictates otherwise. Thus, for example, reference to “a component surface” includes reference to one or more of such surfaces.

For example, voice information refers to information generated as voice signals collected by an audio processing unit to be allocated to time slots. Packet information refers to information generated as data stored in a memory or collected by a camera, data provided from a server and the like to be allocated to time slots.

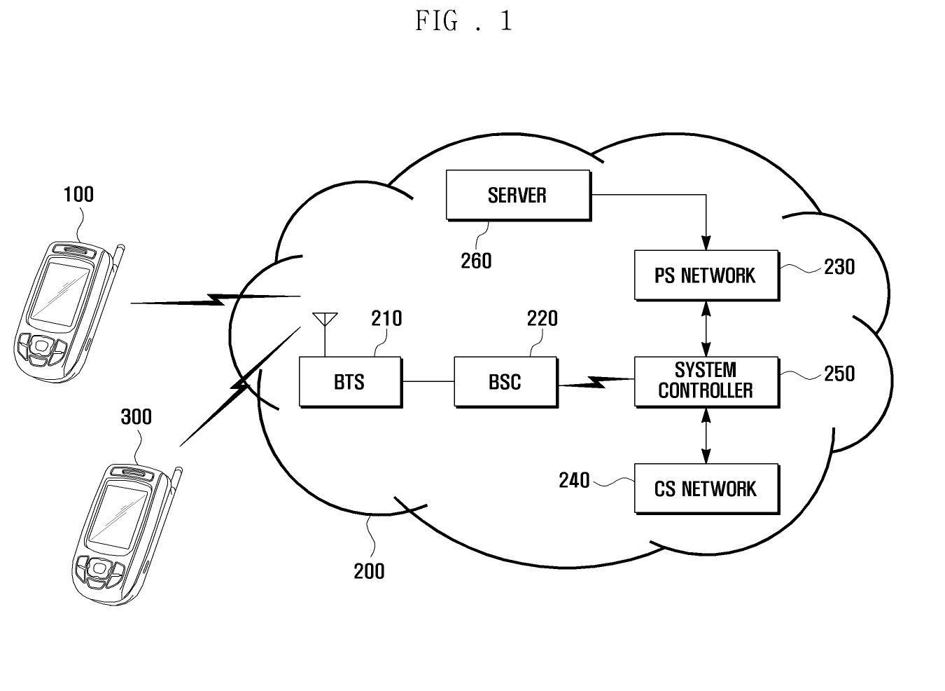

FIG. 1 is a schematic view illustrating a system for communication control in a dual transfer mode according to an exemplary embodiment of the present invention.

Referring to FIG. 1, a communication network system according to an exemplary embodiment of the present invention includes at least one or more portable terminals 100 and 300, and a network system 200 that supports a Dual Transfer Mode (DTM) of the portable terminals 100 and 300.

The portable terminals 100 and 300 transfer information to the communication network system supporting a DTM, according to a time sharing method where particular time slots are used to carry voice information and packet information. That is, the portable terminals 100 and 300 allocate a certain ratio of time slots to be used to transfer voice information and packet information so that the time slots may repeatedly and sequentially be used to carry the voice information and packet information. The portable terminals 100 and 300 also receive voice information and packet information from the network system 200, which is repeatedly and sequentially allocated to time slots. In particular, after allocating based on certain ratio of time slots to transfer voice information and packet information, if there is no voice information to be transferred, the portable terminals 100 and 300 can carry packet information to a time slot previously allocated for voice information and transmit the packet information to the network system 200. For example, when the time slots are allocated according to a ratio of 1:4 to transmit voice information and packet information, the portable terminals 100 and 300 perform an information carrying operation in such a way as to carry voice information to one time slot and packet information to four time slots, and again carry voice information to one time slot and packet information to four time slots. If the portable terminals 100 and 300 do not have voice information to be transferred, i.e., a speaker's voice signal is not generated during a voice call, the portable terminals 100 and 300 can carry packet information to the time slots that have carried voice information and then transmit the packet information. The portable terminals 100 and 300, according to an exemplary embodiment of the present invention may allocate packet information to all the time slots in a DTM, according to whether voice information is generated. The portable terminals 100 and 300 may then transmit the packet information in order to improve data transfer efficiency and improve the network resource efficiency by minimizing empty time slots.

The network system 200 has a network structure so that the allocation of information to time slots used for the portable terminals 100 and 300 may be processed according to transfer modes. That is, the network system 200 processes a corresponding time slot using the network structure. For example, when the portable terminals 100 and 300 transfer information in a DTM, the network system 200 transfers voice information through the Circuit Switched (CS) network and packet information through the Packet Switched (PS) network. The network system 200 includes a Base Transceiver Station (BTS) 210, a Base Station Controller (BSC) 220, a system controller 250, a PS network 230 and a CS network 240.

The BTS 210 establishes communication channels with the portable terminals 100 and 300 and transmits and receives information, such as voice information and packet information and the like. The BTS 210 processes base band signals, converts signals between wired communication and wireless communication, and performs transmit and reception of Radio Frequency (RF) signals. The BTS 210 also serves as a terminal device of a network that is directly connected to the portable terminals 100 and 300. That is, the BTS 210 receives and transmits according to time slots, to which voice information and packet information are allotted, respectively, from and to the portable terminals 100 and 300.

The BSC 220, located between the BTS 210 and the system controller 250, manages and controls the BTS 210. The BSC 220 allocates and releases RF channels for the portable terminals 100 and 300, controls transfer power between the portable terminals 100 and 300 and the BTS 210, operates, maintains and repairs the BTS 210, and performs and sets hand-off between cells set by the BTS 210. In particular, the BSC 220 separates the time slots, to which voice information and packet information are allocated, respectively, from signals that are transferred from the portable terminals 100 and 300 to the BTS 210. The BSC 220 then transmits the separated time slots to the system controller 250. The BSC 220 carries voice information and packet information, transmitted from the system controller 250, to respective time slots according to a certain ratio in one listed packet. The BSC 220 then transfers the voice information and packet information to the BTS 210.

The system controller 250 refers to a network device that is connected to the BSC 220 and provides mobile communication services to portable terminals 100 and 300. The system controller 250 may be implemented with a wired/wireless composite digital switch that provides wired communication and wireless communication. The controller 250 processes basic and added services, processes subscriber's incoming and outgoing calls, processes a location registration procedure and a hand-off procedure, and associates the existing network with other networks. In particular, the controller 250 transmits voice information and packet information that the BSC 220 receives in the time slots to a corresponding CS network 240 and PS network 230, respectively. In an exemplary implementation, the system controller 250 of the monitors the CS network 240 and determines whether the portable terminals 100 and 300 are operating in a DTM to transfer voice information. When the portable terminals 200 and 300 do not transfer voice information, the system controller 250 performs a controlling operation to increase an amount of allocation for transferring packet information through the PS network 230. It is assumed that the network system 200 includes a server 260. More particularly, the portable terminals 100 and 300 switch their voice call mode to a DTM to receive data from the server 260 as well as voice information for a voice call. In an exemplary implementation, the system controller 250 monitors the CS network 240 to determine whether voice information is transferred to the PS network 230, while the server 260 is transmitting data packets, to be transferred to the portable terminals 100 and 300. When the system controller 250 determines that the voice information is not transmitted through the CS network 240, the system controller 250 performs a controlling operation to increase an amount of packet information transmitted through the PC network 230. In an exemplary implementation, the BSC 220 allocates only packet information received from the PS network 230 to time slots and then transfers the packet information to the portable terminals 100 and 300 through the BTS 210.

The PS network 230 converts data, transmitted from the server 260, into packet information and then transmits the converted packet information to the BSC 220 through the system controller 250. The PS network 30 also transmits packet information, which is transmitted from another portable terminal, to the system controller 250. The PS network 230 may adjust the amount of transmitted packet information according to the control of the system controller 250 and then transmits the packet information.

The CS network 240 transfers voice information, transmitted from the other portable terminals, to the BSC 220 through the system controller 250. When voice information is not transmitted from the other portable terminal, i.e., the other portal terminal user does not generate a voice signal, the CS network 240 notifies the system controller 250 that it does not have any voice information to be transmitted.

In a DTM, where packet information and voice information are received from the server 260 or the other portable terminal the network system 200 carries only packet information to time slots to which packet information and voice information are allocated at a certain ratio and then transmits the time slots, when the network system 200 does not have any voice information to be transmitted. Therefore, the network system 200 may improve the data transfer efficiency and the network resource use efficiency.

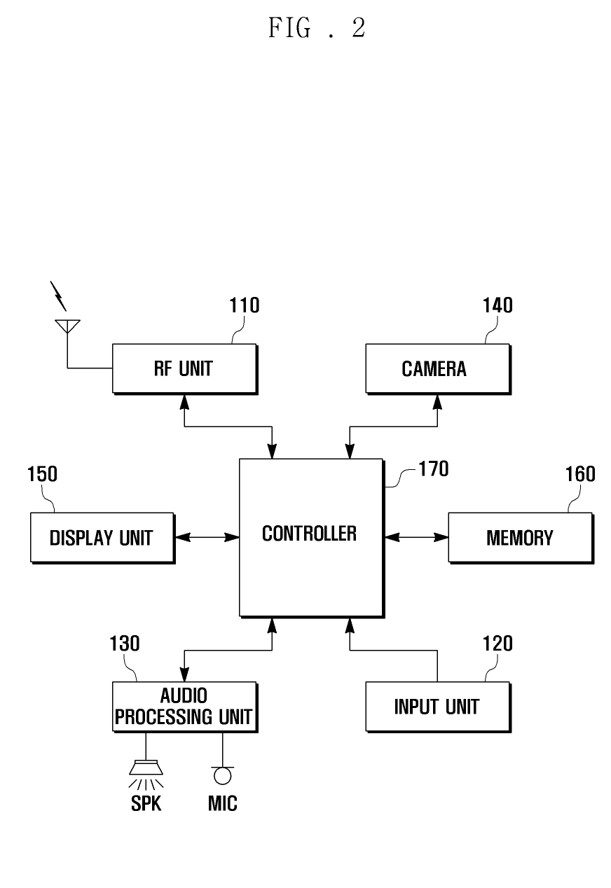

The portable terminals 100 and 300 are explained in detail below with reference to FIG. 2. Since the portable terminals 100 and 300 are implemented in such a way as to have the same elements, the following description will be described with reference to the portable terminal 100.

FIG. 2 is a schematic block diagram illustrating a portable terminal 100 according to an exemplary embodiment of the present invention.

As shown in FIG. 2, the portable terminal 100 includes an RF unit 110, an input unit 120, an audio processing unit 130, a camera 140, a display unit 150, a memory 160 and a controller 170. The camera 140 serves to collect images to be transmitted to the other portable terminal. The portable terminal 100 may not include the camera 140, if the portable terminal does not need to perform image transmission. The portable terminal 100 may include a message generating unit (not shown) for generating messages including a multi-media message or a text message and the like, and serves as a data generating unit for generating data that is transmitted or received based on a DTM. The message generating unit may include the camera 140, the input unit 120 for inputting texts, the memory 160 for providing images and the controller 170 for signal control for writing messages.

The RF unit 110 transmits voice information and packet information in time slots to the network system 200 according to the control of the controller 170. The RF unit 110 also receives voice information and packet information in time slots from the network system 200 and outputs the voice information and packet information to the controller 170. The voice information and packet information may be message information during a voice call, video call information, packet information downloaded during a voice call, and the like. The RF unit 110 includes an RF transmitter for up-converting the frequency of transmitted signals and amplifying the transmitted signals. The RF unit 110 also includes an RF receiver for low-noise amplifying of received RF signals and down-converting the frequency of the received RF signals. The RF unit 110 may simultaneously transmit and receive voice information and packet information using one frequency band.

The input unit 120 inputs numerical or character information. The input unit 120 includes a plurality of input keys and function keys to set a variety of functions. The function keys may include at least one of direction keys, side keys, and shortcut keys and the like, which are set to perform specific functions. The input unit 120 transmits input key signals, related to a user setting and function controls of the portable terminal 100, to the controller 170.

More particularly, the input unit 120 generates key input signals for setting a voice call between the portable terminals 100 and 300, transmitting a message during a voice call, downloading data from a particular server during a voice call, setting a video call between the portable terminals 100 and 300 and transmits the key input signals to the controller 170.

The audio processing unit 130 includes a speaker (SPK) that reproduces voice data transmitted and received during a voice call, voice information transmitted and received in a DTM and audio signals transmitted and received during a video call. The audio processing unit 130 also includes a microphone (MIC) that collects a users' voice or other audio signals during a voice call or a video call.

The camera 140 collects images for a video call when a video call channel is established between the portable terminals 100 and 300. The camera 140 includes a lens for collecting light corresponding to the images, a camera sensor (not shown) for converting light signals into analog electrical signals, i.e., an analog image signal, and a signal processor (not shown) for converting the analog image signal into digital data. In an exemplary implementation, the camera sensor may be implemented by a Charge Coupled Device (CCD) and the signal processor may be a Digital Signal Processor (DSP), but is not limited thereto. The images collected by the camera 140 are stored in the memory 160 and may be transmitted as packet information, between the portable terminals 100 and 300 operating in a DTM, or between a portable terminal and a particular server.

The display unit 150 displays screen interfaces for a voice call, a video call and for transmitting or receiving packet information during a voice call. That is, the display unit 150 may display a screen for inputting a called party's phone number for a voice call, a screen for requesting a call and a screen for displaying a call connection with a called party. After the display unit 150 processes the images collected by the camera 140 in a video call, the display unit 150 may display the images and photographic images transmitted from the other portable terminal in a preview image format. More particularly, the display unit 150 may display a menu screen for selecting particular data stored in the memory 160 in order to transmit or receive data during a voice call. The display unit 150 may also display a screen interface for accessing a particular server to receive data during a voice call, such as, a server homepage provided by operating a web browser. The display unit 150 may be implemented to include a Liquid Crystal Display (LCD). In an exemplary implementation, the display unit 150 may include an LCD controller, a memory for storing data and an LCD device. When the LCD is implemented to employ a touch screen method, the display unit 150 may also serve as an input unit.

The memory 160 stores application programs for executing exemplary functions for a voice call, for a video call, for operating the camera 140 and for user data. More particularly, the memory 160 may provide an application program for supporting a DTM. The memory 160 stores the application program that may increase packet information, according to whether voice information is generated in a DTM and transfers the application program. Furthermore, the memory 160 may buffer, within a certain buffering size, video call data transmitted and received during a video call, and packet information and voice information received in a DTM. The memory 160 may further include a program area and a data area.

The program area stores an Operating System (OS) for booting the portable terminal 100 or 300, application programs for operating the camera 140 and for collecting audio sounds in a video call and an application program for optional functions of the portable terminal 100 or 300, such as, a sound reproducing function and a play back function for an image or moving images. More particularly, an application program, which is stored in the program area, for supporting a DTM is carried according to the control of the controller 170 and supports a voice call between the portable terminals 100 and 300. While the application program is supporting a voice call, the application program collects voice signals from a voice call so that data may be transmitted and received. The application program then converts the voice signals into voice information. The application program then allocates the converted voice information and packet information to time slots according to a certain ratio and allows the portable terminal to transmit voice information and packet information in the time slots.

The data area stores generated data as the portable terminal 100 or 300 operates. It also stores packet information received in a DTM or packet information transferred to the other portable terminal. The packet information includes data recorded by a user in a video call, images collected by the camera 140, user data related to various optional functions provided by the portable terminals 100 and 300 and information corresponding to user data. Examples of the user data may be moving images, phone book data, audio data and corresponding contents. Furthermore, the data area may store voice information according to the control of the controller 170.

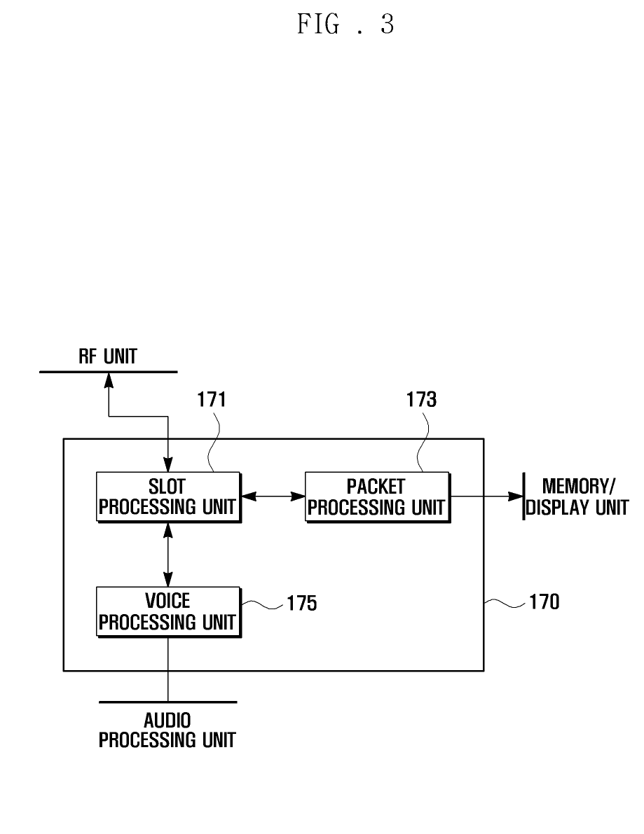

The controller 170 controls signal flows between blocks in the portable terminal 100 and operations of the blocks in order to improve data transmitting and receiving efficiency in a DTM. The controller 170 may include a voice processing unit 175, a packet processing unit 173 and a slot processing unit 171, as shown in FIG. 3.

The voice processing unit 175 processes a signal output from the audio processing unit 130 and a signal from the slot processing unit 171. That is, when the portable terminal 100 or 300 is operated in a DTM, the voice processing unit 175 converts voice signals collected by the audio processing unit 130 into voice information. The voice processing unit 175 then outputs the voice information to the slot processing unit 171. The voice processing unit 175 also receives voice information corresponding to the time slots that the slot processing unit 171 receives from the RF unit 110. The voice processing unit 175 then outputs the voice information to the audio processing unit 130. The voice information includes information that may be allocated to time slots.

The packet processing unit 173 processes data, output from the memory 160 or the camera 140, and then outputs the data to the memory 160 and the display unit 150. The packet processing unit 173 also converts the data into packet information and outputs the packet information to the slot processing unit 171. The packet processing unit 173 receives and processes packet information corresponding to the time slots from the slot processing unit 171, among the signals received through the RF unit 110. The packet processing unit 173 then outputs the packet information to the display unit 150 or the memory 160. That is, the packet processing unit 173 processes packet information allocated to a time slot, where the packet information is output from the slot-processing unit 171, or converts data that the portable terminals 100 and 300 transfer to the external system into packet information, and then outputs the packet information to the slot-processing unit 171. The packet information refers to information that may be allocated to time slots with voice information.

The slot-processing unit 171 allocates, to time slots in a certain ratio, voice information and packet information output from the voice processing unit 175 and the packet-processing unit 173. The slot-processing unit 171 then outputs the information allocated to time slots to the RF unit 110. The slot-processing unit 171 determines information allocated to time slots received by the RF unit 110 and extracts voice information and packet information therefrom. The slot-processing unit then outputs the extracted voice information to the voice-processing unit 175 and the extracted packet information to the packet-processing unit 173. More particularly, the slot-processing unit 171 monitors whether the voice-processing unit 175 generates voice information. When the slot-processing unit 171 determines that the voice-processing unit 175 does not generate voice information, the slot-processing unit 171 requests to increase packet information transferred by the packet-processing unit 173, so that the time slot to which voice information was allocated may carry packet information through the RF unit 110. For example, it is assumed that the slot-processing unit 171 carries one piece of voice information to one of five time slots and four pieces of packet information to the remaining time slots, i.e., four time slots, which is repeated. That is, the slot-processing unit 171 carries voice information and packet information to time slots, as “1 (voice information), 4 (packet information), 1, 4, 1, 4, 1, 4, . . . ”. Accordingly, when the voice-processing unit 175 does not generate voice information, the slot-processing unit 171 carries only packet information to five time slots, “1 (voice information), 4 (packet information), 5 (packet information), 5 (packet information), 5 (packet information), 1 (voice information), 4 (packet information)”.

If voice signals and data are transmitted together, the controller 170 correspondingly coverts voice signals and data into voice information and packet information, respectively. When voice information is not generated, the controller 170 additionally allocates the packet information to the time slots for the voice information and then transmits the time slots in order to improve the data transfer efficiency. Therefore, the portable terminals 100 and 300 may improve the data transfer efficiency during a voice call, the data receiving efficiency during a voice call and the data transmitting and receiving efficiency in a video call.

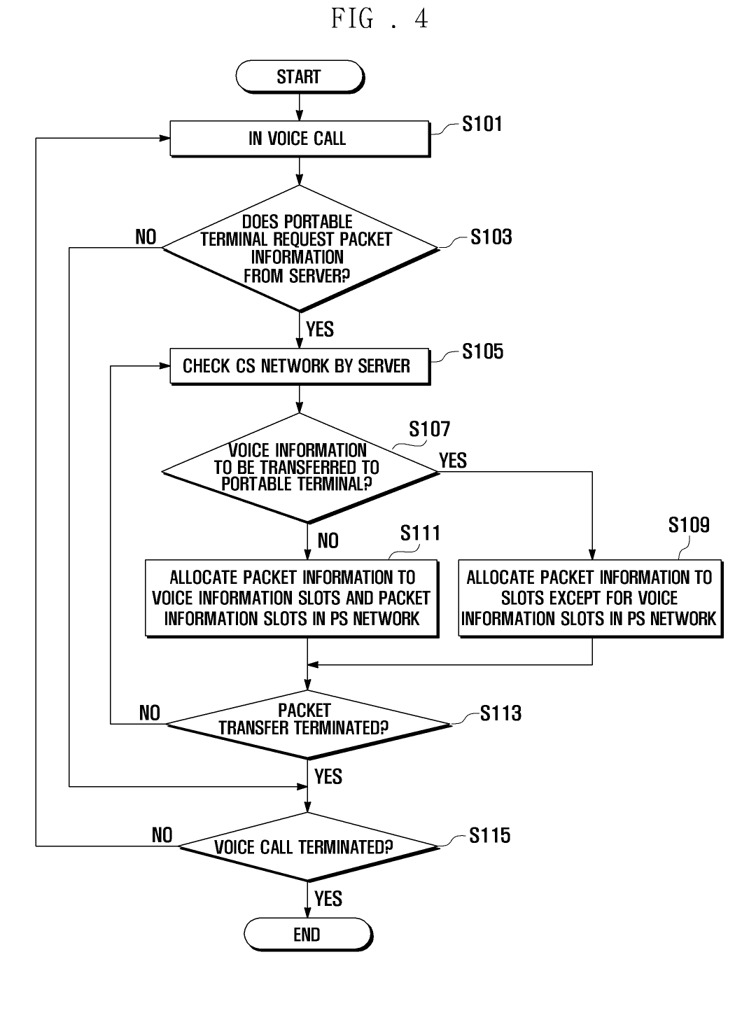

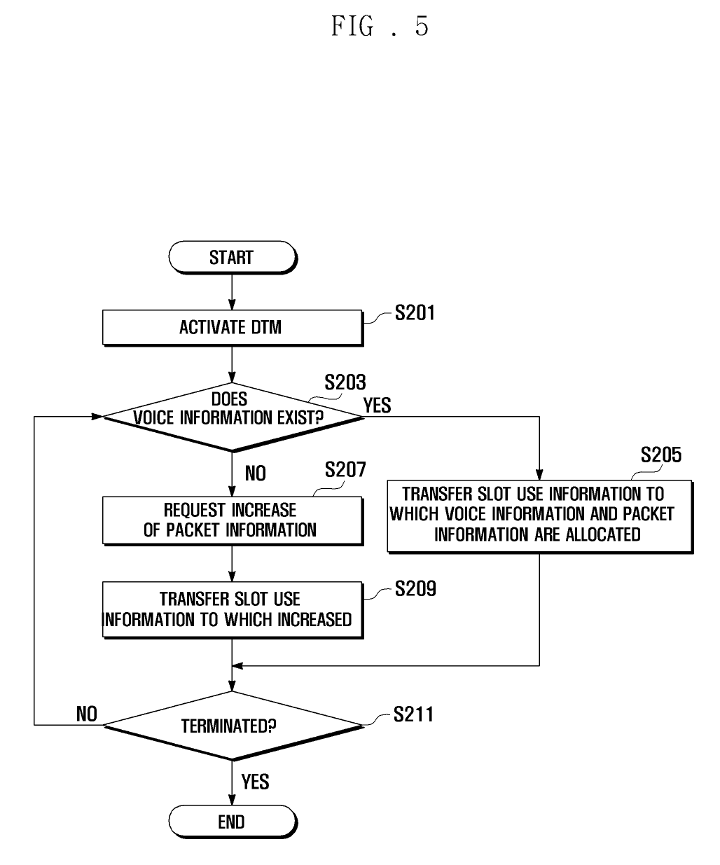

A method for communication control in a DTM, according to an exemplary embodiment of the present invention, is described below. The portable terminals 100 and 300 perform data transmission during a voice call and data reception during a voice call. Also, the portable terminals 100 and 300 are operated in a DTM for a video call, with reference to FIG. 4 and FIG. 5.

FIG. 4 is a flowchart describing a method for communication control in a dual transfer mode according to an exemplary embodiment of the present invention. The flowchart illustrates a method where data is received from a particular server during a voice call.

Referring to FIG. 4, a communication channel for a voice call is established between the portable terminals 100 and 300 in step S101, so that the portable terminals 100 and 300 may perform a voice call.

A determination is made as to whether at least one portable terminal 100 or 300 in a voice call requests packet information for receiving data from a particular server in step S103. In order to download data from the particular server, the portable terminal 100 or 300 activates a server accessible application program, such as a web browser, and inputs an address of a particular server. The portable terminal 100 or 300 searches for the particular server in a network, such as the Internet. After the location search for the particular server has been completed, it is determined whether a communication channel may be established based on protocols, such as TCT/IP or UDP. After completing authentication, the particular server transfers web pages to the portable terminal 100 or 300. The portable terminal 100 or 300 designates particular data to be downloaded from among a variety of data through the web pages and transmits a signal corresponding to the download request to the server.

When the portable terminal 100 or 300 requests packet information from the particular server in order to receive data in step S103, the system controller 250 checks whether voice information is transmitted from the CS network 240 in step S 105. That is, when the server intends to transfer data to the portable terminal and the portable terminal 100 or 300 is in a DTM, the system controller checks the CS network 240 used by the portable terminal 100 or 300 in a voice call. The system controller 250 determines whether there is voice information to be transmitted to the portable terminal 100 or 300 in step S107.

When there is voice information to be transmitted to the portable terminal 100 or 300 in step S107, the system controller 250 allocates packet information to time slots from the PS network 230. The system controller 250 then transmits the packet information to the portable terminal 100 or 300 in step S109, where the time slots, to which packet information is allocated, excludes the time slots to which voice information is allocated, according to a time slot allocation ratio to support a preset DTM. That is, the system controller 250 performs a controlling operation so that voice information and packet information may be transferred, at a certain ratio, from the CS network 240 and the PS network 230, respectively. The transmitted voice information and packet information are combined according to a certain ratio set in the BSC 220. Thus, the combined result is transferred to the portable terminal 100 or 300 through the BTS 210.

On the other hand, when voice information, to be transmitted to the portable terminal 100 or 300, does not exist in step S107, the system controller allocates packet information to time slots previously allocated to transmit voice information so that only packet information may be transferred to a corresponding portable terminal 100 or 300 in step S111. Therefore, when the other portable terminal 100 or 300 does not generate a voice signal during a voice call with the corresponding portable terminal 100 or 300, the corresponding portable terminal 100 or 300 may receive more packet information.

In step S113, the system controller 250 determines whether to complete a transfer of the packet information. If the transfer of the packet information is not completed in step S113, the system controller 250 checks the CS network 240 used by the portable terminal 100 or 300 in step S105 and then performs steps S107, S109 and S111.

On the other hand, if the transfer of the packet information is determined to be terminated in step S113, the system controller 250 determines whether a voice call is terminated in step S115. If a voice call is not terminated in step S115, the system controller 250 returns to step S101. On the contrary, if a voice call is terminated in step S 115, the method ends.

Meanwhile, when the portable terminal 100 or 300 does not request to receive data in step S103, a determination is made as to whether a voice call is terminated in step S115.

As described above, when a portable terminal 100 or 300 is performing a voice call with the other portable terminal 100 or 300 and downloads data from a particular server, the DTM based communication control method performs transfer control to increase an amount of packet information during a period of time when voice information is not transmitted and received therebetween. Accordingly, the data transmitting and receiving efficiency is improved.

FIG. 5 is a flowchart describing a method for communication control in a dual transfer mode, according to an exemplary embodiment of the present invention. The flowchart illustrates a method for improving the data transmitting and receiving efficiency when the portable terminals 100 or 300 are transferring data therebetween in a dual transfer mode.

Referring to FIG. 5, the portable terminals 100 or 300 are activated in a dual transfer mode and perform a voice call therebetween in step S201. The controller 170 of one of the portable terminals 100 or 300, which transfers data to the other portable terminal 100 or 300, determines whether the portable terminal has voice information to be transmitted to the other portable terminal 100 or 300 in step S203. The data refer to messages transmitted and received between the portable terminals 100 or 300, such as, multi-media messages, SMS and the like. The data also refer to video data in a dual transfer mode based video call. The data may also be images, audio files and the like, which are stored in a memory 160.

When the portable terminal 100 or 300 has voice information to be transmitted to the other portable terminal 100 or 300 in step S203, the controller 170 carries voice information and packet information to time slots. The portable terminal 100 or 300 then transfers the voice information and packet information to the other portable terminal 100 or 300 through the RF unit 110 in step S205, where the voice information and packet information is respectively allocated to the time slots. If the data includes messages, the other portable terminal 100 or 300 may be the portable terminal with which a voice call is currently being performed.

On the other hand, when the portable terminal 100 or 300 does not have voice information to be transmitted to the other portable terminal 100 or 300 in step S203, the system controller 250 requests to additionally increase packet information, intended to be transmitted, for the packet processing unit 173 in step S207. The packet processing unit 173 increases the amount of packet information and then transmits the packet information to the slot-processing unit 171. The additional amount of packet information is an amount corresponding to the time slots to which voice information has been allocated.

When the controller receives the amount of added packet information from the packet processing unit 173, the system controller 250 carries the packet information to preset time slots and transfers the packet information to the other portable terminal 100 or 300 through the RF unit 110 in step S209. The transferring of the added packet information continues as long as voice information does not exist.

The system controller 250 determines whether transfer of the packet information is completed in step S2 11. If transfer of the packet information is not completed in step S2 11, the system controller 250 determines whether voice information to be transmitted to the other portable terminal 100 or 300 exists in step S203. When the voice-processing unit generates voice information, the system controller 250 may interrupt the voice processing unit 175 so that additional packet information, corresponding to the amount of previously allocated time slots, may be received.

Therefore, when portable terminals operating in a DTM transfer packet information therebetween an amount of packet information to be transferred, according to whether voice information exists, increases. Accordingly, the data transmitting and receiving efficiency and network resource user efficiency for transferring packet information are improved.

As described above, the system, device and method for communication control in a dual transfer mode, according to exemplary embodiments of the present invention, may improve the use efficiency of a network resource and the transfer rate.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for communication control in a dual transfer mode, the method comprising:
performing a voice call by a portable terminal, based on a dual transfer mode;
requesting, by the portable terminal in a voice call, to download data from a server;
determining whether voice information exists to be transmitted to the portable terminal;
allocating data, intended to be transmitted to the portable terminal, to time slots previously allocated to transfer voice information, if voice information does not exist; and
transmitting the allocated data to the portable terminal.

2. The method of claim 1, wherein the determining of whether the voice information exists comprises determining whether voice information exists that is to be transmitted to from a circuit switched network.

3. The method of claim 1, wherein the allocating of the data to the time slots comprises:
converting the data into packet information allocated to dual transfer mode based time slots;
carrying packet information to time slots previously carried to transfer packet information; and
allocating packet information to time slots previously allocated to transfer voice information.

4. The method of claim 3, wherein the transferring of the allocated data to the portable terminal comprises transferring packet information, allocated to the time slots, to the portable terminal from a packet switched network.

5. The method of claim 1, wherein the voice information comprises voice signals, which are transferred to the portable terminal from another portable terminal and converted into signals suitable to be allocated to dual transfer mode based time slots.

6. A method for communication control in a dual transfer mode, the method comprising:
performing a voice call by a portable terminal, based on a dual transfer mode;
generating, by at least the portable terminal, data to be transmitted;
determining whether the portable terminal comprises voice information to be transmitted;
carrying the data to time slots previously allocated to transfer voice information, if the portable terminal does not have voice information; and
transmitting the carried data.

7. The method of claim 6, wherein the generating of the data to be transmitted comprises at least one of collecting video data using a camera, generating multi-media message based data or text message based data and selecting at least one of an image file based data and audio file based data stored in a memory.

8. The method of claim 6, wherein the voice information comprises voice signals, which are transferred from the portable terminal to another portable terminal and converted into signals to be allocated to dual transfer mode based time slots.

9. The method of claim 6, wherein the carrying the data to the time slots and the transmitting of the carried data comprises:
converting the data into packet information to be carried on to the time slots;
carrying the packet information to time slots which number corresponding to a preset number of slots to carry the packet information; and
carrying the packet information to time slots which number correspond to a preset number of slots to carry the voice information.

10. A system for communication control in a dual transfer mode, the system comprising:
one or more portable terminals for performing a voice call in a dual transfer mode; and
a network system for supporting resources for the voice call and for performing a controlling operation to transfer data, to at least one portable terminal, through time slots previously allocated to transfer voice information, when the at least one portable terminal requests to download data therefrom,
wherein the data is transferred according to whether voice information exists that is to be transmitted to the at least one portable terminal requesting to download data.

11. The system of claim 10, wherein the network system comprises:
a circuit switched network for processing the voice information;
a packet switched network for processing the data;
a system controller for checking the circuit switched network and for performing, when voice information to be transmitted does not exist, a controlling operation to transmit the data through the time slots previously allocated to transfer the voice information;
a Base Station Controller (BSC) for allocating at least one of the voice information and the packet information to time slots; and
a Base Transceiver Station (BTS) for establishing communication channels with the portable terminals and for transferring information allocated by the BSC to a corresponding portable terminal.

12. The system of claim 11, wherein the packet switched network converts the data into packet information for allocating to time slots for a dual transfer mode.

13. The system of claim 12, wherein the system controller monitors the circuit switched network, requests to increase an amount of packet information transmitted to the at least one portable from the packet switched network, when voice information to be transmitted does not exist, and transmits the increased amount of packet information to the BSC.

14. The system of claim 13, wherein the BSC carries the voice information and the packet information to time slots previously allocated a certain ratio to transmit the time slots to the BTS, and allocates received packet information to the time slots, which are previously allocated to transfer voice information and packet information to transmit the time slots the BTS.

15. The system of claim 10, wherein the voice information comprises voice signals, which are transferred from the at least one portable terminal to another portable terminal and converted into signals suitable to be allocated to dual transfer mode based time slots.

16. A device for communication control between portable devices performing a voice call in a dual transfer mode comprising, the device comprising:
an audio processing unit for collecting voice signals communicated between the portable devices during a voice call;
a data generating unit for generating data communicated between the portable devices in a dual transfer mode;
a Radio Frequency (RF) unit for transferring the voice signals and the data to another portable device; and
a controller for performing a controlling operation to transfer data in time slots previously allocated to transfer the voice signals, when the collected voice signals do not exist.

17. The device of claim 16, wherein the controller comprises:
a voice processing unit for converting the voice signals into voice information allocated to time slots for the dual transfer mode and for converting voice information received by the RF unit into voice signals;
a packet processing unit for converting the data into packet information allocated to time slots for the dual transfer mode and for converting packet information received by the RF unit into data; and
a slot processing unit for at least one of separating voice information and packet information from signals received by the RF unit and carrying voice information and packet information, output from the voice processing unit and the packet processing unit onto time slots at a ratio for transmitting the data to the RF unit.

18. The device of claim 17, wherein the slot-processing unit requests from the packet-processing unit to increase an amount of packet information to be transmitted, when the voice information is not generated, and carries the increased amount of packet information to the time slots previously allocated to transfer voice information for transmitting the data slots to the RF unit.

19. The device of claim 16, wherein the data generating unit comprises:
a camera for collecting images;
a memory for storing at least one of image files and audio files; and
a message generating unit for generating messages comprising at least one of multi-media messages and text messages.

20. The device of claim 19, wherein the message generating unit comprises:
an input unit for inputting text messages; and
a controller for signal control for writing messages.
